(19) United States
(12) Patent Application Publication
(10) Pub. No.: US 2012/0162257 A1
(43) Pub. Date: Jun. 28, 2012

(54) AUTHENTICATION APPARATUS AND METHOD FOR PROVIDING AUGMENTED REALITY (AR) INFORMATION

(75) Inventor: Young-Sin Kim, Suwon-si (KR)

(73) Assignee: PANTECH CO., LTD., Seoul (KR)

(21) Appl. No.: 13/247,773

(22) Filed: Sep. 28, 2011

(30) Foreign Application Priority Data
Dec. 27, 2010 (KR) 10-2010-0135571

(51) Int. Cl. G09G 5/00

(52) U.S. Cl. 345/633

(57) ABSTRACT

A authentication method for providing augmented reality (AR) information includes acquiring an image of a real-world environment including a target object; identifying the target object in the acquired image; requesting data related to the target object to a server; receiving encoded data related to the target object from the server; authenticating the encoded data; and outputting the authenticated data as AR information. A terminal to perform authentication to provide AR information includes a communication unit to receive and transmit a signal from and to a server; a display to output a target object and data related to the target object; and a controller to receive encoded data related to the target object from the server, to authenticate the encoded data, and to output the authenticated data on the display.

### CROSS-REFERENCE TO RELATED APPLICATION

This application claims priority from and the benefit under 35 U.S.C. §119(a) of Korean Patent Application No. 10-2010-0135571, filed on Dec. 27, 2010, which is incorporated by reference for all purposes as if fully set forth herein.

### BACKGROUND

1. Field

The following description relates to an apparatus and method for providing Augmented Reality (AR) information.

2. Discussion of the Background

Augmented Reality (AR) relates to a computer graphic technique of synthesizing a virtual object or virtual information with a real-world environment such that the virtual object or virtual information may be integrated into the real-world environment.

AR may synthesize virtual objects based on the real-world environment to provide additional information that may not be easily obtained from the real-world environment, unlike existing Virtual Reality (VR) that targets virtual spaces and virtual objects. Due to the characteristic of AR, unlike the existing VR that has been applied to limited fields, such as computer games, the AR can be applied to various real-world environments. As a result, AR has come into the spotlight as a next-generation display technique that may be suitable for a ubiquitous environment.

In order to provide AR information, a procedure of authenticating users having authority to use the AR information may be used. Conventionally, a user may visit an AR provider's web site to register himself or herself as a member of the website in advance. Once the user is registered, the AR provider may authenticate the user according to the user's registered information, such as the user's characteristics and authority based on the previously registered user information, when the user requests the AR provider to send AR information. If the user is properly authenticated, the AR provider provides the user with the AR information according to the result of the authentication.

However, the conventional authentication method for providing AR information has an inconvenience of requiring pre-registration. Furthermore, the conventional authentication method has to open users' personal information to AR providers through the pre-registration process, which may cause a risk of possible personal information leakage.

### SUMMARY

Exemplary embodiments of the present invention provide an authentication apparatus and a method for providing Augmented Reality (AR) information.

Additional features of the invention will be set forth in the description which follows, and in part will be apparent from the description, or may be learned by practice of the invention.

Exemplary embodiments of the present invention provide an authentication method for providing AR information including acquiring an image of a real-world environment including a target object; identifying the target object in the acquired image; requesting data related to the target object to a server; receiving encoded data related to the target object from the server; authenticating the encoded data; and outputting the authenticated data as AR information.

Exemplary embodiments of the present invention provide a method for providing AR information including receiving a signal for requesting data related to a target object from a terminal; searching for the data related to the target object; encoding the identified data related to the target object; and transmitting the encoded data to the terminal.

Exemplary embodiments of the present invention provide a terminal to perform authentication to provide AR information including a communication unit to receive and transmit a signal from and to a server; a display to output a target object and data related to the target object; and a controller to receive encoded data related to the target object from the server, to authenticate the encoded data, and to output the authenticated data on the display.

Exemplary embodiments of the present invention provide an authentication apparatus to provide AR information including a communication unit to receive and transmit a signal from and to a terminal; and a controller to receive a signal requesting data related to a target object from the terminal, to identify the data related to the target object, to encode the identified data related to the target object, and to output the encoded data to the terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an Augmented Reality (AR) system according to an exemplary embodiment of the invention.

FIG. 2 is a diagram illustrating a terminal to provide AR information according to an exemplary embodiment of the invention.

FIG. 3 is a diagram illustrating a server to provide AR information according to an exemplary embodiment of the invention.

FIG. 4 is a flowchart illustrating an authentication method for providing AR information according to an exemplary embodiment of the invention.

FIG. 5 is a flowchart illustrating a method for encoding data related to a target object according to an exemplary embodiment of the invention.

FIG. 6 is a flowchart illustrating a method for decoding data related to a target object according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ). Throughout the drawings and the detailed description, unless otherwise described, the same drawing reference numerals are understood to refer to the same elements, features, and structures. The relative size and depiction of these elements may be exaggerated for clarity, illustration, and convenience.

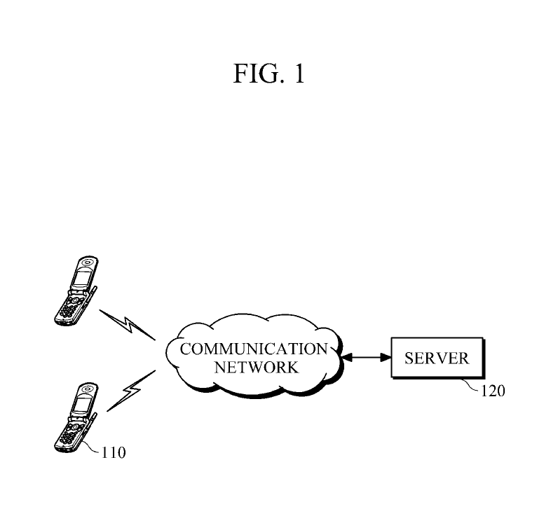

FIG. 1 illustrates an Augmented Reality (AR) system according to an exemplary embodiment of the invention.

Referring to FIG. 1, the AR system includes at least one terminal 110 connected to a server 120, which provides the terminal 110 with information related to AR services or AR information through a communication network.

In an example, the terminal 110 may be a mobile communication terminal, such as a mobile phone, a smart phone, a Personal Digital Assistants (PDA), a navigation terminal and the like. Further, the terminal 110 may instead be a personal computer, such as a desktop computer, a tablet computer, a notebook and the like. In an example, the terminal 110 may be applied to various kinds of devices that can acquire AR information for one or more target objects that may be found in an image of a real-world environment from the server 120 and overlap the AR information on the image of the real-world to display AR data.

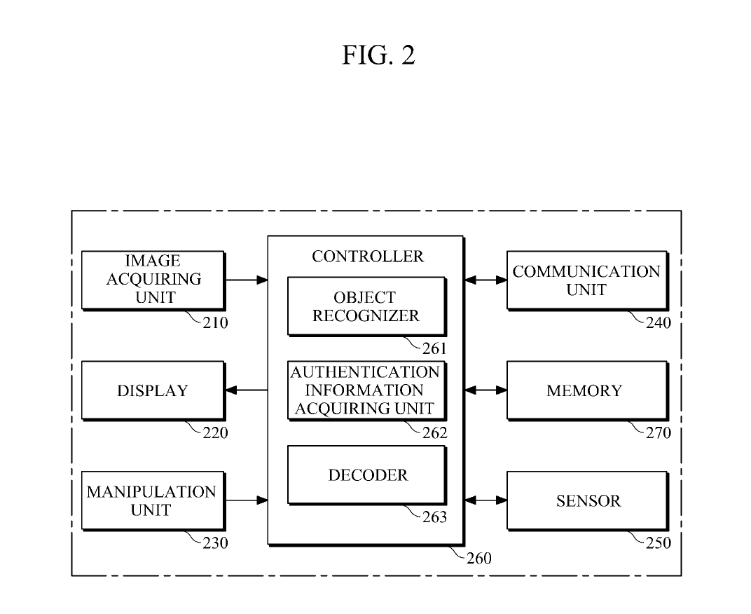

FIG. 2 is a diagram illustrating a terminal to provide AR information according to an exemplary embodiment of the invention.

Referring to FIG. 2, the terminal includes an image acquiring unit 210, a display 220, a manipulation unit 230, a communication unit 240, a sensor 250, a controller 260, and a memory 270.

The image acquiring unit 210 may acquire an image by photographing an image of a real-world environment, which may include a target object. The image acquiring unit 210 may also output the acquired image to the controller 260. In addition, the image acquiring unit 210 may process image frames, such as still images or moving images, with environment information which may be obtained from a sensor 250. In an example, the image acquiring unit 210 may be a camera or other image acquiring device, including a CMOS image sensor. Further, the image acquiring unit 210 may also adjust the size of acquired images or rotate the acquired images automatically or manually under the control of the controller 260. Although not illustrated, the image acquiring unit 210 may also reside externally from the terminal 110 and may be a separate device. For simplicity in disclosure, however, the image acquiring unit 210 is described as being included in the terminal 110.

The display 220 may output or display received images. In an example, the display 220 may include a liquid crystal display (LCD) that can display images or text. The display 220 may be installed in the terminal 110 or connected to the terminal 110 through an interface device, such as a universal serial bus (USB) port. The display 220 may output and display information processed by the terminal 110, and may also display a User Interface (UI) or a Graphic User Interface (GUI) related to control operations. Also, the display 220 may include a sensor component to receive user input, such as a touch sensor. In an example, the touch sensor may have a layered structure, which may allow the display 220 to be used as a manipulation unit.

The manipulation unit 230 may receive user input. In an example, the manipulation unit 230 may be a user interface, which receives input information from a user. The manipulation unit 230 may include a key input unit that generates key information whenever one or more key buttons are pressed, a touch sensor, a mouse, a key pad, or the like.

The communication unit 240 may receive transmission signals through a communication network, process the received signals, output the processed signals to the controller 260, process internal signals from the controller 260, and transmit the processed signals through the communication network.

The sensor 250 may capture environment information. The environment information may include location information of the terminal 110, which may be acquired in real time, image acquiring direction, position information of the terminal 110, such as a tilt position of the terminal 110 when the image is acquired, speed at which the image acquiring direction changes, current time, time at which the image was acquired, and the like. The sensor 250 may also output the captured information to the controller 260. The sensor 250 may include a Global Position System (GPS) receiver that receives signals containing the location information of the terminal 110 transmitted from a GPS satellite, a gyro sensor that captures and outputs an azimuth, azimuth angle, and/or inclination angle of the terminal 110, and an accelerometer that measures the rotation direction of the terminal 110.

The controller 260 may be a hardware processor to control the individual components described above, or a software module that may be executed in a hardware processor. The controller 260 may include an object recognizer 261, an authentication information acquiring unit 262, and a decoder 263.

The object recognizer 261 may identify a target object included in the image acquired by the image acquiring unit 210 and extract one or more characteristic information of the identified target object. Characteristic information of the target object may include an edge, a color, a contrast of the target object, and/or other identifying information. In addition, characteristic information may also include marker-based object information including a Quick Response (QR) code. The object recognizer 261 may process the characteristic information of the target object into a signal and transmit the signal to request data related to the target object to the server 120 through the communication unit 240. The server 120 may receive the transmitted signal from the terminal 110, and in response the server 120 may transmit encoded data or non-encoded data related to the target object to the requesting terminal 110. In an example, the encoded data may include a flag, which may include authentication information that may be used to decode the encoded data.

The authentication information acquiring unit 262 may acquire authentication information to decode the encoded data related to the target object, which may be received from the server 120 through the communication unit 240. The authentication information may include a key, a marker, time information, or location information of the target object and/or the terminal 110. Time information may refer to the time at which the target object was acquired or transmitted by the terminal 110. Also, the encoded data related to the target object may include a flag related to authentication information, and the authentication information acquiring unit 262 may acquire authentication information corresponding to a value stored in the flag.

If the key is stored as authentication information in the flag, the authentication information acquiring unit 262 may receive a key value from the user through the manipulation unit 230, or detect a key value stored in the memory 270. Also, if location or time information is stored as authentication information in the flag, the authentication information acquiring unit 262 may acquire location or time information through the sensor 250. One or more pieces of authentication information may be stored in the flag. If the authentication information includes both a key value and time information, the authentication information acquiring unit 262 may acquire both the key value and time information.

After the authentication information acquiring unit 262 acquires the authentication information, the decoder 263 may decode the received data related to the target object, which may be encoded, and output the decoded data through the display 220.

The operation of the controller 260 will be described in more detail in an authentication method for providing AR, which will be described later.

The memory 270 may store the data related to the target object and authentication information received from the server 120. For example, if a user of the terminal 110 visits a museum and buys an admission ticket, authentication information, such as a key, may be assigned to the terminal 110. The authentication information or key may be inputted by the user through the manipulation unit 230 and stored in the memory 270. In addition, the authentication information or key may also be received from the server 120 through the communication unit 240 and stored in the memory 270.

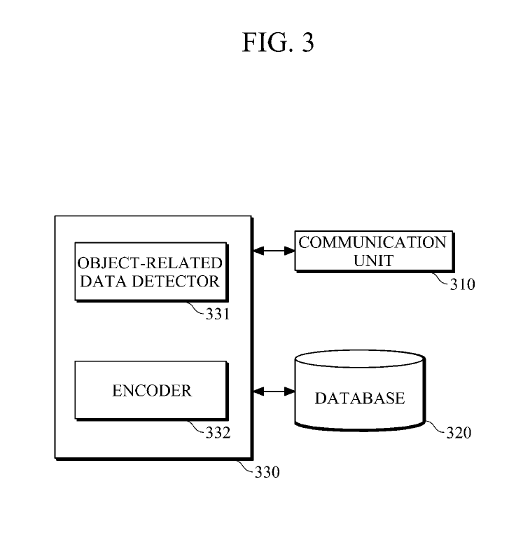

FIG. 3 is a diagram illustrating a server according to an exemplary embodiment of the invention.

Referring to FIG. 3, the server includes a communication unit 310, a database 320, and a controller 330. The communication unit 310 may process signals received from a terminal 110 through a communication network, output the processed signals, process internal output signals from the controller 330, and transmit the processed signals through the communication network.

The database 320 may store object recognition information related to one or more target objects found in an image of a real-world environment and data mapped to the object recognition information. The object recognition information may contain one or more characteristic information of the target objects, including edges, colors, contrasts and/or other identifying information of the target objects. In an example, the object recognition information may be classified as non-encoded data requiring no authentication and encoded data requiring authentication. Authentication information may be mapped to the encoded data. For example, if marker information displayed on the admission ticket is used to receive data about pictures exhibited in the museum, the marker information may be mapped as authentication information.

The controller 330 controls the individual components described above to encode the data related to the target object and to provide the encoded data to a terminal. The controller 330 may be a hardware processor to perform the operation or a software module that may be executed in a hardware processor. More specifically, the controller 330 may include an object-related data detector 331 and an encoder 332.

If the server receives a signal requesting data related to a target object from the terminal 110 through the communication unit 310, the object-related data detector 331 may search for the corresponding data related to the target object from the database 320. That is, the object-related data detector 331 may compare characteristic information of the target object included in the received signal with the object recognition information included in the database 320. If the received characteristic information of the target object corresponds to the stored object recognition information, the object-related detector 331 is determined to have identified the recognition information related to the target object. The identified recognition information related to the target object may include encoded data and non-encoded data.

The encoder 332 may encode the non-encoded data identified by the object-related data detector 331, and may set a flag to indicate authentication information for decoding the encoded data. Also, the controller 330 may create authentication information, such as a key, which may be used to decode the encoded data, and transmit the authentication information to the corresponding terminal.

The operation of the controller 330 will be described in more detail in the authentication method for providing AR, which will be described later.

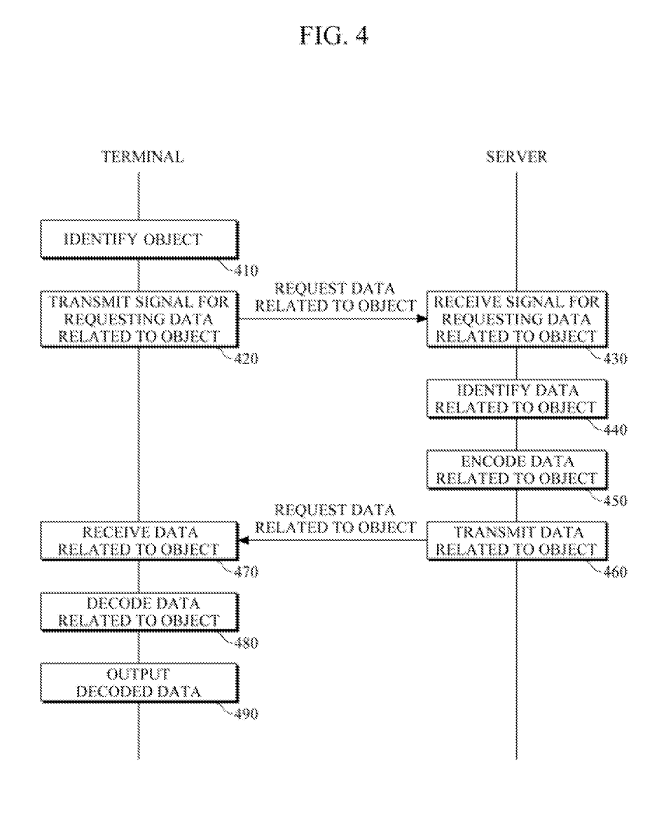

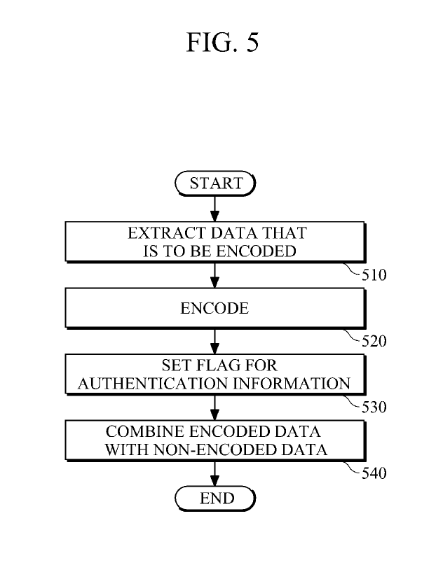

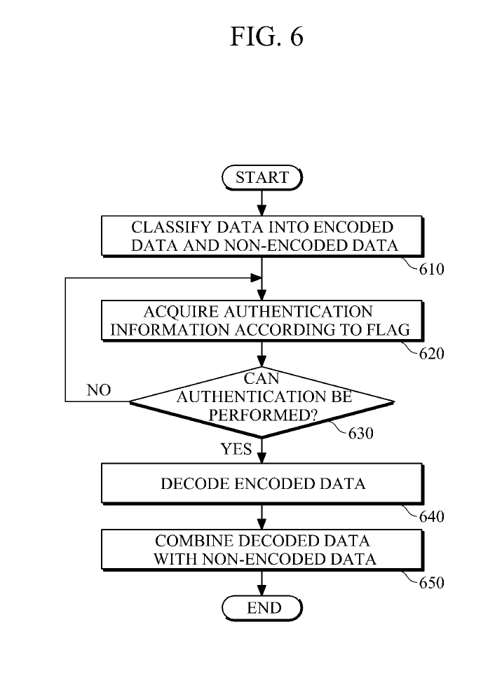

Hereinafter, an AR providing method, which will be described as if performed in the AR system described above, will now be described in more detail with reference to FIG. 4, FIG. 5, and FIG. 6.

FIG. 4 is a flowchart illustrating an authentication method for providing AR information according to an exemplary embodiment of the invention.

In operation 410, a terminal identifies a target object included in image data, which may be an image of a real-world environment. For example, if image data is an image acquired in a museum, the target object may be a statute or an artifact included in the acquired image. The image data or the image may also include auditory data. In operation 420, the terminal transmits a signal to request data related to the target object to a server. The signal to request data related to the target object may include characteristic information related to the target object. The characteristic information may include an edge, a color, a contrast of the target object and/or other identifying information. Characteristic information may also include marker-based object information including a Quick Response (QR) code.

In operation 430, the server receives the transmitted signal from the terminal requesting data related to the target object. In operation 440, the server searches and identifies the data related to the target object corresponding to the transmitted signal from a database. More specifically, the server may search for object recognition information mapped to the characteristic information of the target object, which may be included in the transmitted signal requesting the data related to the target object.

In operation 450, the server encodes the identified data related to the target object, which will be described in more detail with reference to FIG. 5 below.

FIG. 5 is a flowchart illustrating a method for encoding the data related to a target object according to an exemplary embodiment of the invention.

Referring to FIG. 5, the server extracts data that is to be encoded from the identified data (510). In operation 520, the server encodes the extracted data. Also, in operation 530, the server may set a flag for the encoded data, which may include authentication information that may be used to decode the encoded data. If there are one or more pieces of data that are to be encoded, the server may set separate flags for the individual pieces of data. If the server sets two or more flags for a piece of data that is to be encoded, the server may combine the encoded data with non-encoded data (540).

Returning again to FIG. 4, the server transmits the data related to the target object including the encoded data and/or non-encoded data to the corresponding terminal (460). The terminal receiving the data related to the target object from the server (470) decodes the received data related to the target object (480), and outputted for display (490). The process of decoding the received data will be described with reference to FIG. 6 below.

FIG. 6 is a flowchart illustrating a method for decoding the data related to a target object according to an exemplary embodiment of the invention.

Referring to FIG. 6, the terminal classifies the received data into encoded data and non-encoded data (610). Then, the terminal checks for a flag in the encoded data and acquires authentication information stored in the flag, if the flag for the encoded data is present (620). For example, if a key is stored in the flag as authentication information, the terminal may receive the key through a manipulation unit (e.g., manipulation unit 230 of FIG. 2) or retrieve the key stored in a memory component of the terminal (e.g., memory 270 of FIG. 2). The key stored in the memory may be a value inputted by a user or transmitted from the server.

In an example, if time information or location information is stored in the flag, the terminal may acquire the time information or location information of the target object and/or the terminal through a sensor (e.g., sensor 250 of FIG. 2). In an example, time information may refer to the time at which the target object was acquired or transmitted by the terminal. Also, if there are two or more flags set for the encoded data, the terminal may acquire two or more pieces of authentication information.

The terminal determines whether authentication can be performed based on the acquired authentication information (630). If no authentication can be performed based on the acquired authentication information, the process returns to operation 620 so that the terminal may again attempt to acquire authentication information.

If authentication can be performed based on the acquired authentication information, the terminal decodes the encoded data using the authentication information (640). Further, in operation 650, the decoded data and the non-encoded data may be combined to be outputted (650). Different parts of the encoded data may be decoded according to the authentication information. For example, if the authentication information is location information, different kinds of data may be decoded according to the location information. Accordingly, only a part of the encoded data may be decoded based on the acquired authentication information. Also, the entire encoded data may be decoded using the authentication information.

In an example, if a terminal's user visits a certain book café and tries to acquire a lendable book list of the book café, the terminal may acquire an image of the book café including the book café's logo. The terminal may identify the book café's logo as a target object, transmit the book café's logo to a server, and then receive data related to the target object, which may include location information corresponding to the book café, from the server. If the received location information is determined to be that of the book café, the received data related to the target object may include an encoded lendable book list of the book café. The terminal may decode the encoded lendable book list for the respective book café using the location information as authenticating information.

In another example, a user possessing a terminal may visit one of many exhibition halls that may be assigned different authentication information, such as keys, according to admission fees. In this case, the user's terminal may acquire an image of the respective exhibition hall with a target object, identify the target object included in the image, receive authentication information according to the admission fee for the respective exhibition hall among data related to the target object, and decodes a part or all of the data related to the target object using the authentication information. That is, the range of data that can be decoded may be differentiated according to authentication keys.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An authentication method for providing Augmented Reality (AR) information, comprising:
acquiring an image of a real-world environment comprising a target object;
identifying the target object in the acquired image;
requesting data related to the target object to a server;
receiving encoded data related to the target object from the server;
authenticating the encoded data; and
outputting the authenticated data as AR information.

2. The method of claim 1, wherein authenticating the encoded data comprises:
checking flag information comprising authentication information for decoding the encoded data related to the target object;
extracting authentication information corresponding to the flag information from the encoded data; and
decoding the encoded data related to the target object using the extracted authentication information.

3. The authentication method of claim 2, wherein the authentication information comprises at least one of a key, time information, and location information related to the target object,
wherein time information is a time at which the image is acquired.

4. The method of claim 1, wherein authenticating the encoded data comprises classifying a part of the encoded data into decodable data according to authentication information.

5. The method of claim 2, wherein outputting the authenticated data as AR information comprises combining decoded data with non-encoded data and outputting a result of the combined data.

6. An authentication method for providing Augmented Reality (AR), comprising:
receiving a signal for requesting data related to a target object from a terminal;
identifying the data related to the target object;
encoding the identified data related to the target object; and
transmitting the encoded data to the terminal.

7. The method of claim 6, wherein encoding the identified data related to the target object comprises:
extracting data related to the target object; and
encoding the extracted data.

8. The method of claim 6, wherein encoding the identified data related to the target object comprises setting a flag comprising authentication information for decoding the encoded data.

9. The method of claim 6, wherein transmitting the encoded data to the terminal comprises:
combining the encoded data with non-encoded data; and
transmitting a result of the combined data to the terminal.

10. The method of claim 6, further comprising:
creating authentication information for decoding the encoded data; and
transmitting the authentication information to the terminal.

11. The method of claim 6, wherein the authentication information comprises at least one of a key, time information, and location information related to the target object or the terminal,
wherein the time information is the time in which an image including the target object was acquired or received.

12. A terminal to perform authentication to provide Augmented Reality (AR) information, comprising:
a communication unit to receive and transmit a signal from and to a server;
a display to output a target object and data related to the target object; and
a controller to receive encoded data related to the target object from the server, to authenticate the encoded data, and to output the authenticated data on the display.

13. The terminal of claim 12, wherein the controller extracts encoded data from the received data related to the target object and authenticates the extracted data.

14. The terminal of claim 12, further comprising:
a sensor to capture environment information;
an image acquiring unit to acquire an image of a real-world environment comprising the target object;
a manipulation unit to receive a user input; and
a memory to store authentication information,
wherein the controller checks for flag information, acquires authentication information corresponding to the flag information, and decodes the data related to the target object according to the acquired authentication information.

15. The terminal of claim 14, wherein the environment information comprises at least one of an image acquiring direction, position information of the terminal, speed at which image acquiring direction changes, current time information, time at which the image of the real-world environment comprising a target object was acquired, and location information related to the target object or the terminal.

16. The terminal of claim 14, wherein the authentication information comprises at least one of a key, time information, and location information related to the target object or the terminal,
wherein the time information is the time at which the image is acquired or received.

17. The terminal of claim 12, wherein the controller combines decoded data with non-encoded data and outputs the result of the combined data through the display.

18. An authentication apparatus to provide Augmented Reality (AR) information, comprising:
a communication unit to receive and transmit a signal from and to a terminal; and
a controller to receive a signal requesting data related to a target object from the terminal, to identify the data related to the target object, to encode the identified data related to the target object, and to output the encoded data to the terminal.

19. The apparatus of claim 18, wherein the controller extracts data related to the target object, and encodes the extracted data.

20. The apparatus of claim 18, wherein the controller:
creates authentication information; and
sets a flag comprising authentication information,
wherein the authentication information is used to decode the encoded data.
